(19) United States
(12) Patent Application Publication
(10) Pub. No.: US 2015/0190921 A1
(43) Pub. Date: Jul. 9, 2015

(54) TOOL BOX

(71) Applicant: SHYH-MING WANG, Taichung City (TW)

(72) Inventor: SHYH-MING WANG, Taichung City (TW)

(21) Appl. No.: 14/147,536

(22) Filed: Jan. 5, 2014

(51) Int. Cl. B25H 3/02; B65D 25/28; B65D 21/02

(52) U.S. Cl. CPC B25H 3/023; B65D 21/0204; B65D 25/28

(57) ABSTRACT

A tool box is provided, including a board member and a connecting member. Each lateral face of the board member is formed with a first connecting portion, and a mounting hole is disposed in each first connecting portion. Two ends of the mounting hole are respectively formed with a second connecting portion. Each second connecting portion is detachably assembled in the mounting hole. The board member can be connected with another board member through the connecting members, and each lateral side can be connected with the board members.

### BACKGROUND OF THE INVENTION

1. Field of the Invention

The present invention relates to a tool box.

2. Description of the Prior Art

Most of the tool boxes on the market are composed of a box and a lid. The box and the lid are pivoted to each other and can swing relatively. The box is formed with receiving space for receiving tools; therefore, users can carry their tools with the box. However, only limited types and numbers of tools can be put into this kind of tool box, so users often have to carry different tool boxes to meet the requirements at work. Since the tool boxes are unable to be adjusted to suit users' needs, it is complicated for users to store or organize. In addition, the pivoted parts of the box and the lid of the tool box are often designed to be dislocation, so to make the tool box requires two molds, the box and the lid. Plastic molds are expensive, so the cost of manufacturing the tool box increases. Furthermore, the boxes and lids of most of the tool boxes now can only be folded up face-to-face or opened in 180 degrees, so the tool boxes cannot be assembled together in various combinations.

The present invention is, therefore, arisen to obviate or at least mitigate the above-mentioned disadvantages.

### SUMMARY OF THE INVENTION

In view of above-mentioned disadvantages, the main object of the present invention is to provide a tool box, which needs only a single mold to make a board member and can be connected on a plane or into three-dimensional structure or be piled up with connecting members.

To achieve the above and other objects, the present invention provides a tool box, including at least two board members and a connecting member. Each board member has two corresponding surfaces and a plurality of lateral faces, wherein one of the surfaces is formed with at least one tool receiving portion, each lateral face is at least formed with a first connecting portion, the first connecting portion of each board member is arranged in corresponding position, each end of the connecting member has a second connecting portion parallel to each other, each second connecting portion is detachably assembled to the first connecting portion. The corresponding position of the first connecting portion of each board member and the cooperation of the connecting members, the board members can be connected on a plane, piled up or assembled into a three-dimensional structure, and the second connecting portions disposed at two ends of the connecting member and parallel to each other enable the board member to pivotally swing 270 degree at most.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIGS. 2 to 8 are drawings showing the present invention in use;

FIGS. 9 to 13 are illustrations of other embodiments of the present invention.

### DETAILED DESCRIPTION OF THE PREFERRED EMBODIMENTS

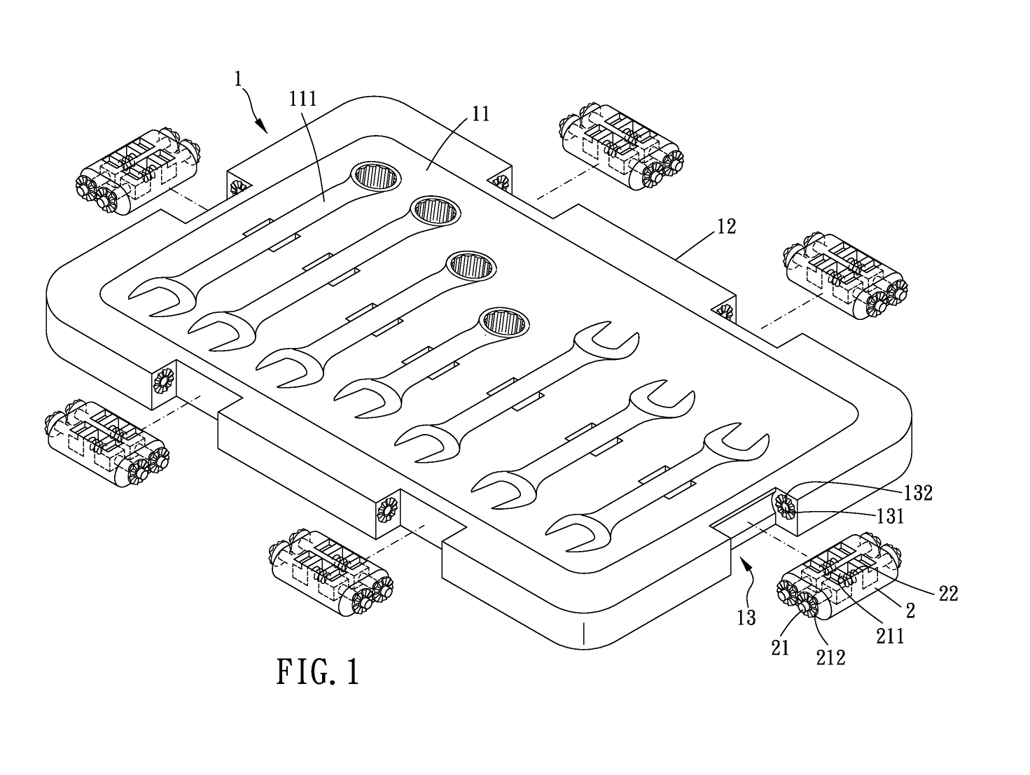

Please refer to FIG. 1 for a tool box of the present invention, including a board member 1 and a plurality of connecting members 2, and the board member 1 is a rectangle board and has two corresponding surfaces 11 and a plurality of lateral faces 12, wherein one of the surfaces 11 is formed with a plurality of tool receiving portions 111. In this embodiment, the tool receiving portions 111 are receiving troughs whose shape resemble to that of tools. A plurality of lateral faces of the board member 1 include two long lateral faces and two short lateral faces, and each long lateral face and each short lateral face are formed with at least one first connecting portion 13 (the size of the first connecting portion 13 can be increased or reduced in accordance with the size of the board member 1). The first connecting portion 13 is a recession recessed inward on the lateral face 12 of the board member 1, and the recession is disposed through the two surfaces 11 of the board member 1. Two corresponding sides of the first connecting portion 13 of each recession are formed with two mounting holes 131. Each end of the connecting member 2 is provided with a second connecting portion, and each second connecting portion is detachably assembled in the mounting holes 131. Specifically, each second connecting portion has two retractable connecting axles 21 (the two connecting axles 21 are arranged in interval and parallel to each other). The two connecting axles 21 of the second connecting portion are assemblable in or disassemblable from the two mounting holes 131 of the first connecting portion 13 through retractability and stretchability. Preferably, each parallel connecting axle 21 is formed with two separate axial rods. An end of each separate axial rod of each connecting axle 21 is exposed, and the other end is connected with a shifting block 211. Preferably, an exposed part is protruded from the unparallel connecting end of the shifting block 211 for fingers to press or hold thereon. Each shifting block 211 used to connect the two connecting axles 21 with each other can be pressed toward the other shifting block 211 so as to drive the two connecting axles 21 to retract, and each second connecting portion is formed with an elastic member 22. Specifically, the elastic member 22 is disposed between the two shifting blocks 211 which is used to connect the separate axial rods. The elastic member 22 is abutted against the shifting block 211 to drive the two connecting axles 21 to be assemblable in or disassemblable from the mounting holes 131. When the two connecting axles 21 is disposed in the mounting holes 131, the board member 1 and the connecting member 2 will connect with each other. On the contrary, when the connecting axles 21 is removed from the mounting holes 131, the board member 1 and the connecting member 2 will separate from each other.

In addition, the first connecting portion 13 is formed with a first toothed portion 132 near the mounting hole 131. The connecting axle 21 of each second connecting portion is formed with a second toothed portion 212. When the connecting axle 21 of the second connecting portion is assembled in the mounting hole 131, the first toothed portion 132 will be position-restrictedly engaged against the second toothed portion 212. The effect of position-restricted engagement helps to decrease the friction between the board member 1 and the connecting member 2, so they will not easily get loose or pivotally swing. Furthermore, if there is no need for position-restricted engagement, in other embodiments, the first connecting portion can be pivoted to the second connecting portion, and the connecting axle can be rotatably inserted in the mounting hole so as to allow the two board members to pivotally swing through the connecting member.

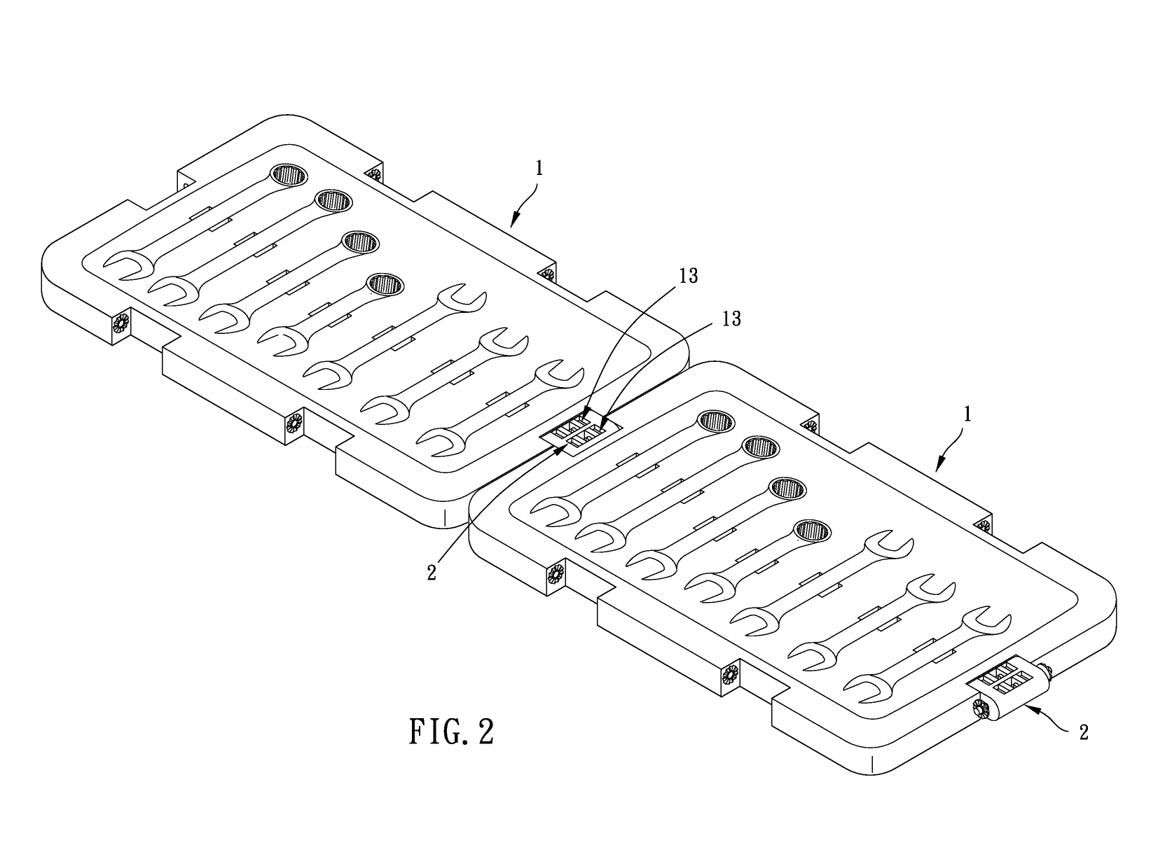

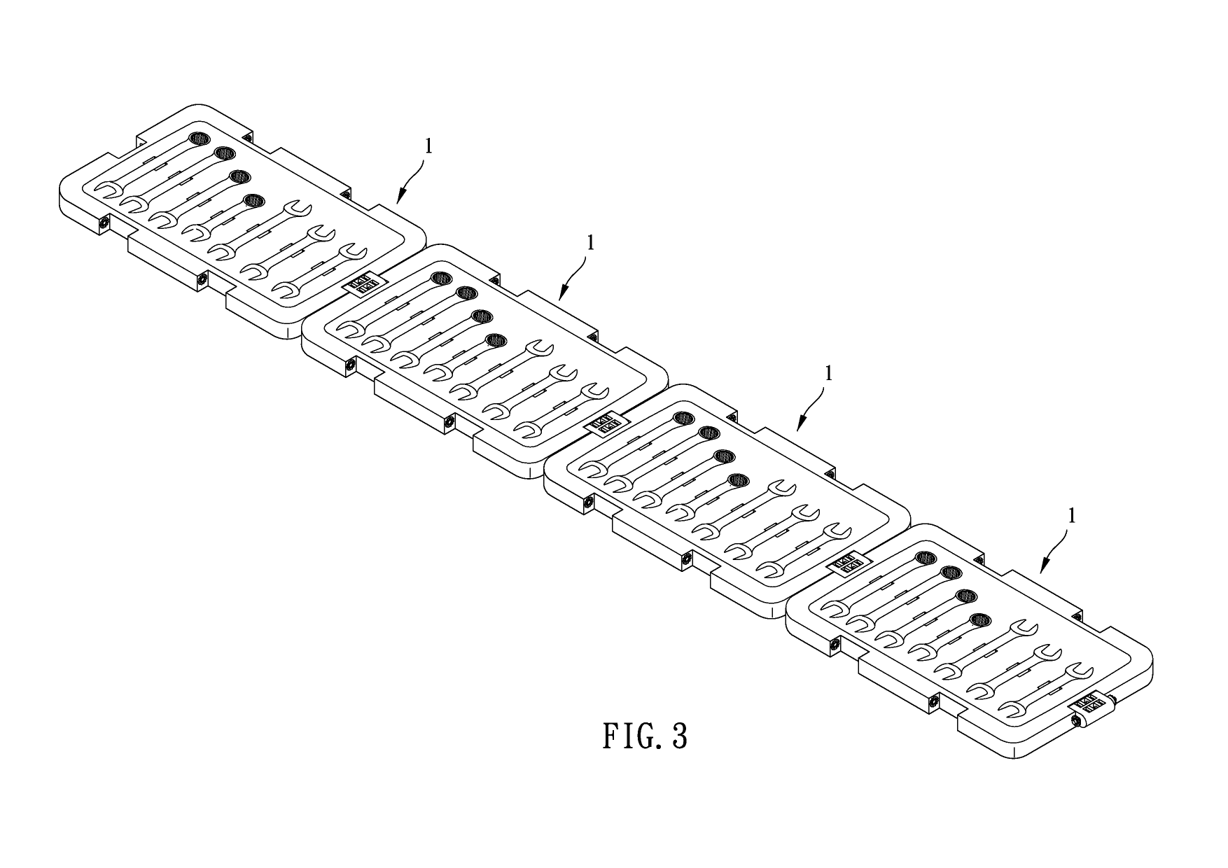

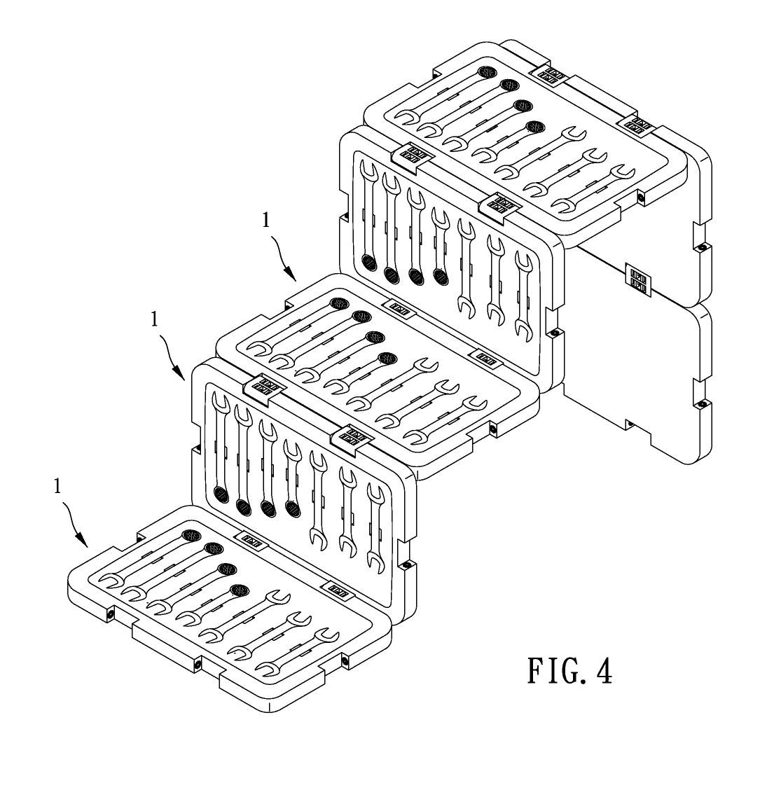

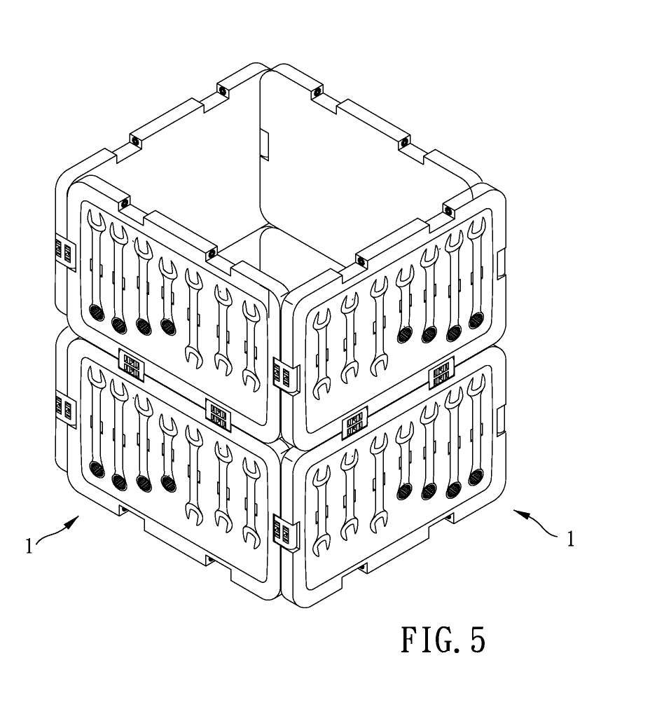

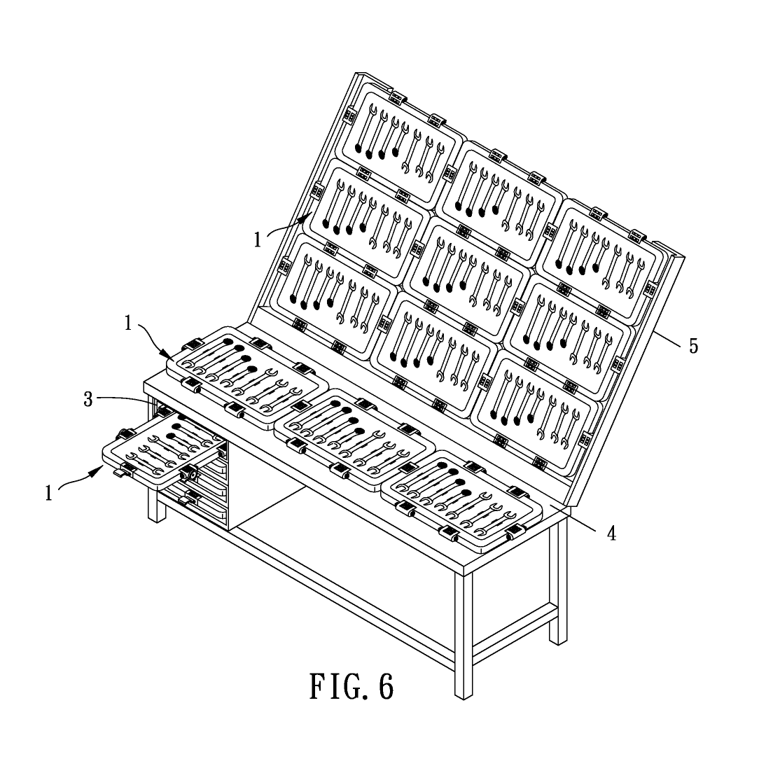

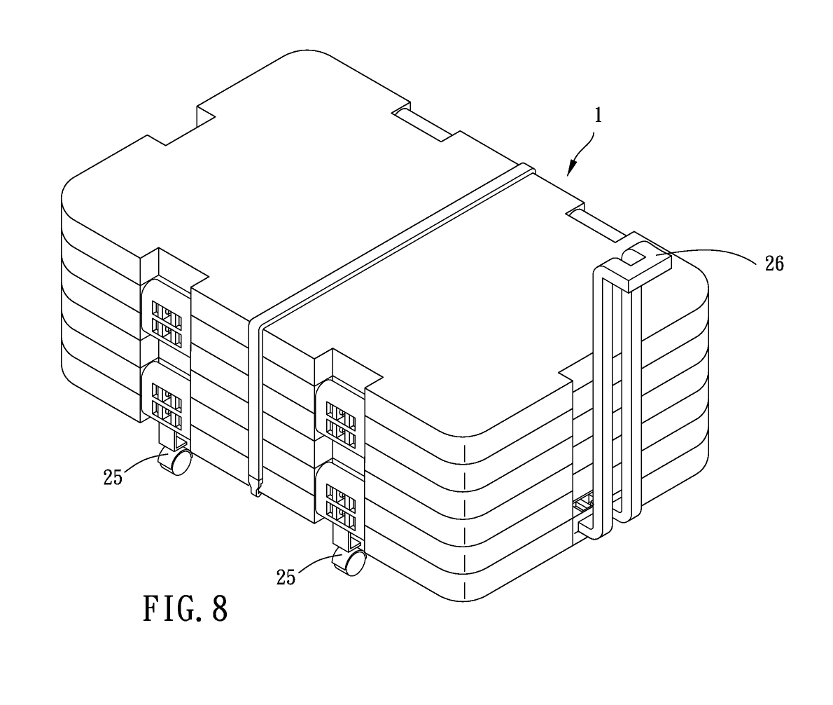

Thereby, in actual use, each board member 1 is assembled to another board member 1 through the connecting member 2 (please refer to FIGS. 1 and 2), which means that two the second connecting portions of the connecting member 2 are used to respectively assemble to the two board members 1 to combine the tool boxes of the present invention. In other ways of application, a plurality of connecting members can be assembled to a plurality of board members to form a plane (FIG. 3), a stepped structure (FIG. 4) or a three-dimensional structure (FIG. 5). Users can assemble the board members according to their preferences or environmental needs, and the board members can be separated and piled up after use, so it is convenient and practical. Furthermore, in this embodiment, the first connecting portions 13 of the two board members 1 are correspondingly arranged, so the first connecting member 13 of the two board members 1 can aim at and be assembled to the connecting member 2 when the two board members are assembled together (shown in FIG. 2). Through the arrangement of the connecting members 2, the first connecting portion of the present invention doesn't need to be processed with staggered position (the conventional connecting structures are arranged in staggered position, so it has problems such as difficulty for processing and oblique pivotal axle). Therefore, compared to the exist tool boxes which require at least two molds, the present invention requires only a single mold of board member and helps to decrease 50% of the cost of molding. Furthermore, through the first connecting portions and connecting members correspondingly disposed, the stability of the connection among boards becomes stronger, and the board members in one shape can be connected on a plane (shown in FIGS. 3 and 6), piled up (shown in FIG. 8) or assembled into a three-dimensional structure (shown in FIGS. 4 and 5).

In addition, the tool box of the present invention can be combined and placed on a working desk (please refer to FIG. 6). Part of the board members 1 is disposed in a drawer 3 of the working desk, part of the board members 1 can be placed on the desk surface 4, and part of the board members 1 can be obliquely disposed on an L-bracket 5 so as to achieve the function of storage and display.

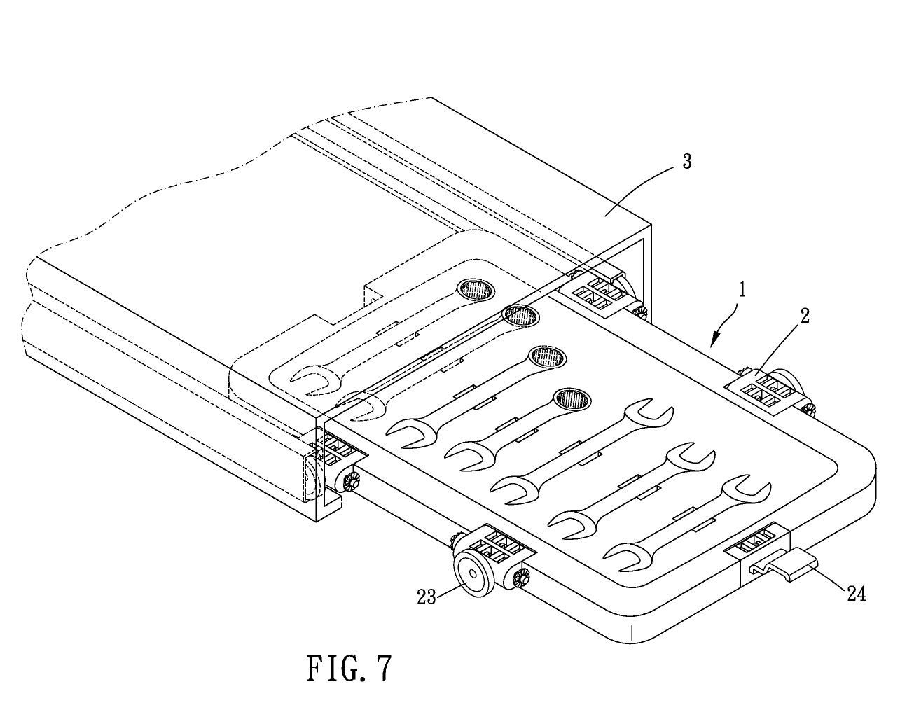

In other ways of application, the connecting member can be provided with a roller and a handle to increase its practicability. Please refer to FIGS. 6 and 7, the connecting members 2 disposed on the two sides of the board member 1 are formed with detachable rollers 23. The rollers 23 correspond to sliding channels of the drawer 3. An end of the connecting member 2 is provided with a handle 24 in upside-down U shape. Therefore, the board member 1 can be slidably disposed in the drawer 3, and the handle 24 can be used to drag and move the board member 1 (wherein mounting holes can be provided on the connecting members 2 for the roller 23 and the handle 24 to assemble therein). Please refer to FIG. 8 for another way of application. A plurality of board members 1 are piled up, the connecting members 2 at the bottom are provided with rollers 25 which can move on the ground, and the connecting members 2 at an end are formed with an extended and bent auxiliary handle 26. Thereby, the board members 1 which are piled up can be moved like a car being pushed so as to increase the convenience of moving the board members 1. Besides, the first connecting portion on the long lateral face is pivoted to the connecting member in staggered position, so users can hold on to the top board member to quickly display the board members on a plane like FIG. 3 and can quickly find the tools they need. The above-mentioned roller, handle, auxiliary handle and connecting member can also be integrally disposed, but it is preferable that the roller, handle or auxiliary handle are movably inserted or connected so as to decrease the cost of molding.

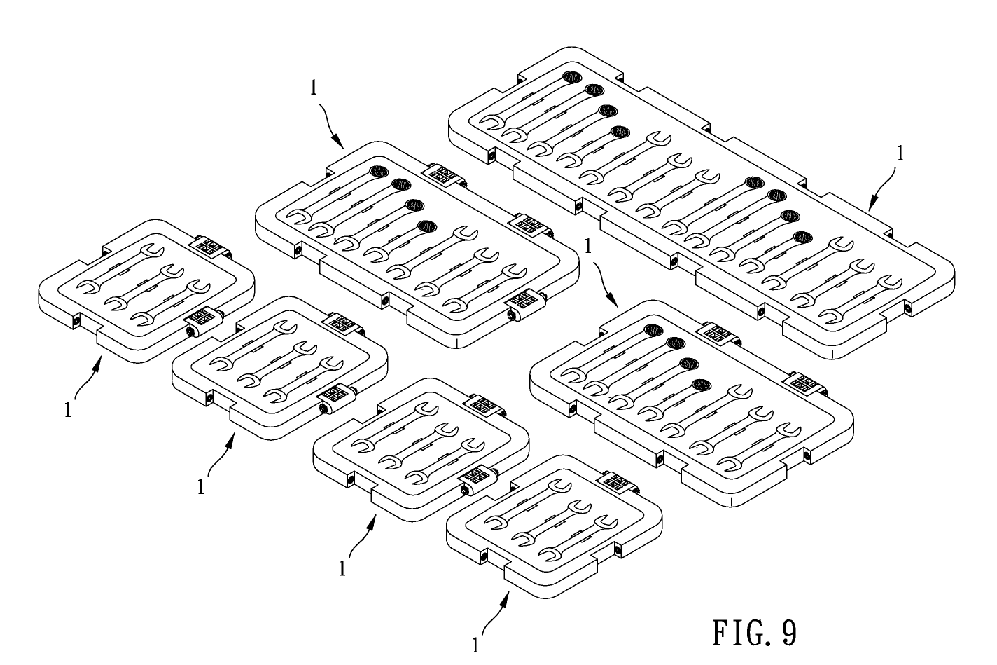

In addition to the above-mentioned embodiments, the size of the board member 1 can be adjusted such as a large board member 1′ shown in the upper-right corner of FIG. 9. The long lateral face of the large board member 1′ is provided with four first connecting portions for the connecting members to pivotally connect thereto. In the middle of FIG. 9 is a medium board member 1. The long lateral face of the medium board member 1 is provided two first connecting portions for the connecting members to pivotally connect thereto. The two medium board members 1 can be pivoted with each other to construct a large board member 1′. A small board member 1″ is shown in the lower-left corner of FIG. 9. The long lateral face and the short lateral face of the small board member 1″ are respectively a single first connecting portion cooperating with a single connecting member. Two of the small board members 1″ can be pivoted together to construct a medium board member 1, and four of the small board members 1″ can be assembled into a large board member 1′. Through the change of size of the board members, users can not only connect the board members in one size but also assemble the board members in different sizes to construct a display wall.

Furthermore, in other embodiments, the first connecting portion can be disposed only on two lateral faces of the board member, and the two lateral faces formed with the first connecting portions are two neighboring lateral faces; thereby, two board members can be connected to the two neighboring lateral faces of a board member. However, the flexibility of this embodiment is not as good as that of the embodiment whose long and short lateral faces are both formed with the first connecting portion.

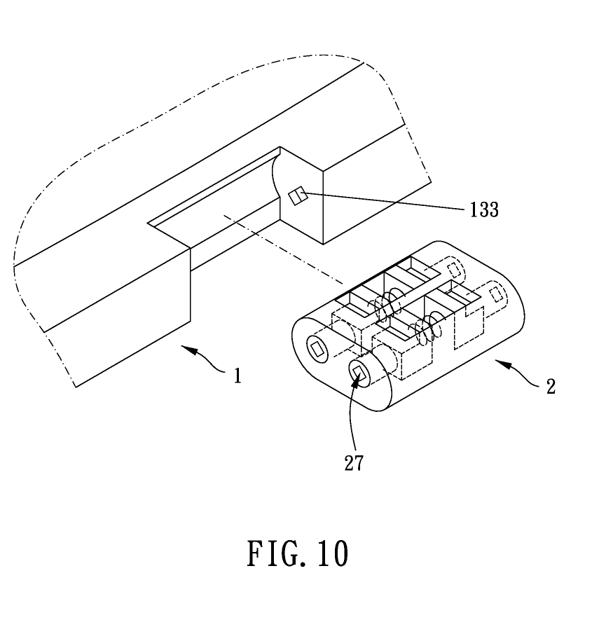

In other embodiments (please refer to FIG. 10), the two lateral faces of the first connecting portion of the board member 1 can be mounting holes, and the two lateral faces of the recession can also be formed with two protruding blocks 133 (it has to be polygonal) protruded on the same axle. The two connecting portions are formed with two connecting axles parallel to each other, and the two parallel connecting axles are two separate axial rods. An end of each separate axial rod is exposed, and the other end is connected with a shifting block. An elastic member is disposed between and abutted against the two shifting blocks. The exposed end of the axial rod of the connecting axle is formed with a bearing hole 27. The two connecting axles are assemblable to or disassemblable from the two protruding blocks 133 when the shifting block is pressed.

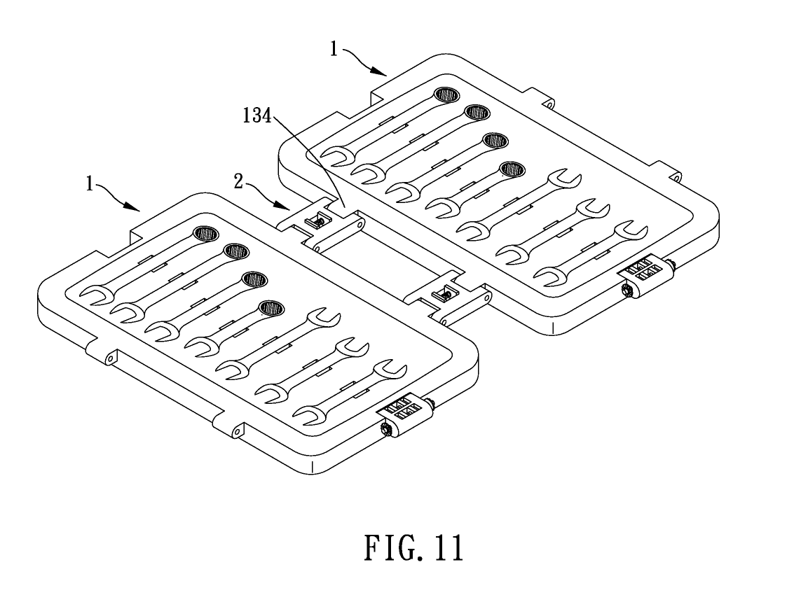

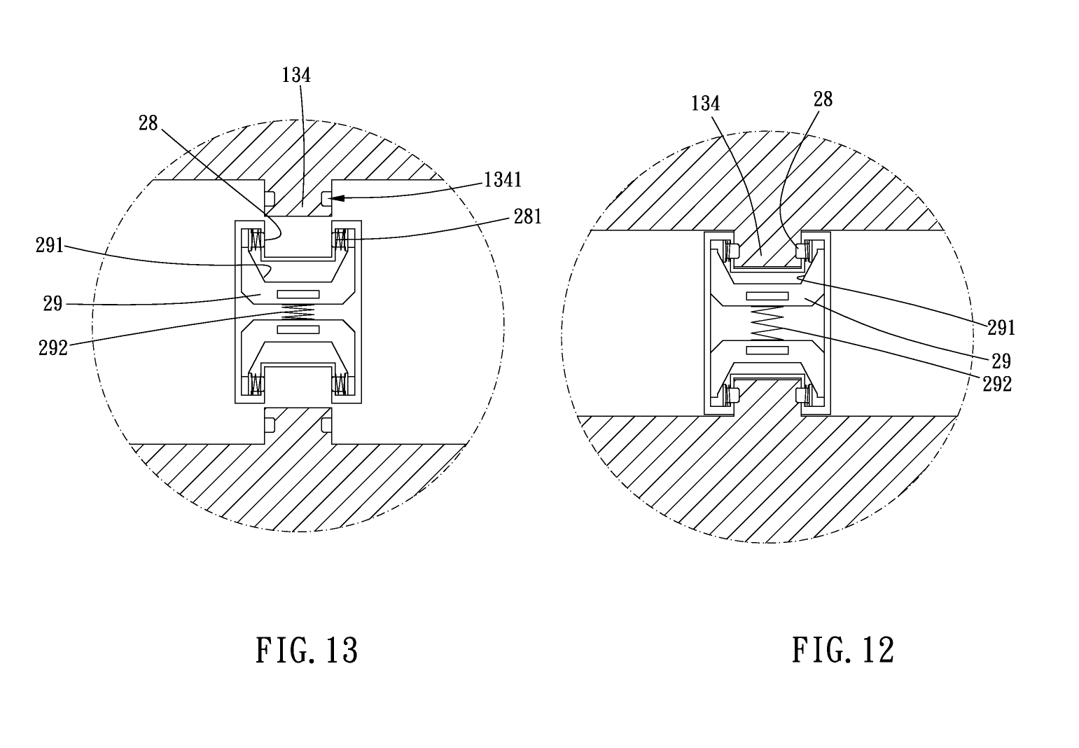

Moreover, in other embodiments of the present invention (please refer to FIGS. 11 to 13), the first connecting portion of the board member 1 is the protruding portion 134 protruded on the lateral face of the board member 1. Preferably, two ends of the protruding portion 134 are aligned with the two surfaces of the board member 1. Two corresponding lateral faces of the first connecting portion of the protruding portion 134 are formed with a mounting hole 1341. The second connecting portion of each connecting member 2 is a receiving hole, and the receiving hole is formed with two movable positioning protrusions 28. Through movement, the positioning protrusion 28 can extend into the receiving hole. The second connecting portion has an abutting member 29 which is substantially in upside-down U shape, and the abutting member 29 has an oblique face 291. The positioning protrusion 281 is formed with an elastic member 281, and the elastic member 281 can abut against the positioning protrusion 28 to move toward the oblique face 291. When the abutting member 29 is moved, it drives the oblique face 291 to abut against the positioning protrusion 28 so as to achieve the aim of controlling the positioning protrusion 28 to restrictedly move in the receiving hole; therefore, the positioning protrusion 28 can be used to be fixedly inserted in the mounting hole 1341 (wherein the two second connecting portions are design as a pair, the elastic member 292 is disposed between the two abutting members 29, so the two abutting members 29 can elastically abut against each other and move toward the other end). Thereby, when being assembled, the protruding portion 134 extends in the receiving hole, and the two positioning protrusions 28 are rotatably inserted in the two mounting holes 1341. Because the elastic member 281 and the oblique face 291 are abutted against each other, the positioning protrusion 28 will remain fixedly disposed in the mounting hole 1341 (shown in FIG. 12). When being disassembled, the abutting member 29 is moved backward (the two abutting members 29 can be clipped on and moved backward at the same time), and the thickness of the oblique face 291 will decrease so as to allow the positioning protrusion 28 to retract from the mounting hole 1341 (shown in FIG. 13) and to separate the connecting member 2 from the board member 1. Consequently, when the present invention is designed or manufactured, the first connecting portion could be a protruding or a recessed structure in accordance with various requirements.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A tool box, including at least two board members and a connecting member, each board member having two corresponding surfaces and a plurality of lateral faces, wherein one of the surfaces is formed with at least one tool receiving portion, each lateral face is formed with at least one first connecting portion, the first connecting portions of each board member are correspondingly arranged, two ends of the connecting member are respectively formed with a second connecting portion, each second connecting portion is detachably assembled with the first connecting portion of each board member, and a plurality of the board members are selectively connected on a plane, piled up or assembled into a three-dimensional structure.

2. The tool box of claim 1, wherein the first connecting portion of each board member is a recession recessed inward on the lateral face of the board member, the recession is disposed through the two surfaces of the board member, and the recession is a mounting hole provided for the second connecting portion to be assembled therewithin.

3. The tool box of claim 2, wherein the first connecting portion is formed with a first toothed portion near the mounting hole, each second connecting portion is provided with a second toothed portion, and when the second connecting portion is assembled within the mounting hole, the first toothed portion will be position-restrictedly engaged with the second toothed portion.

4. The tool box of claim 3, wherein the recession is provided with two the mounting holes, the second connecting portion is provided with two connecting axles parallel to each other, the two parallel connecting axles are two separate axial rods, an end of each separate axial rod is exposed and the other end is connected with a shifting block, and an elastic member is disposed between and abutted against the two shifting blocks, so that the two connecting axles of the second connecting portion are assemblable in or disassemblable from the two mounting holes by pressing the shifting block.

5. The tool box of claim 1, wherein the first connecting portion of each board member is a recession recessed inward on the lateral face of the board member, the recession is disposed through the two surfaces of the board member, the recession is formed with two protruding blocks, the second connecting portion is provided with two connecting axles parallel to each other, the two parallel connecting axles are two separate axial rods, an end of each separate axial rod is exposed and the other end is connected with a shifting block, an elastic member is disposed between and abutted against the two shifting blocks, the end of the axial rod of each connecting axle is formed with a bearing hole, and by pressing the shifting block, the two connecting axles are assemblable in or disassemblable from the two protruding blocks with the bearing holes.

6. The tool box of claim 1, wherein the first connecting portion is a protruding portion protruded from the lateral face of the board member, two corresponding sides of the protruding portion are respectively formed with a mounting hole, and two ends of the protruding portion are aligned with the two surfaces of the board member.

7. The tool box of claim 6, wherein the second connecting portion is formed with a receiving hole, two movable positioning protrusions are disposed in the receiving hole, the protruding portion extends into the receiving hole, and the two positioning protrusions are inserted into the two mounting holes.

8. The tool box of claim 1, wherein the connecting member is provided with a roller, a handle or an auxiliary handle.

9. The tool box of claim 8, wherein the connecting member is movably assembled with the roller, the handle or the auxiliary handle.
